(19) United States
(12) Patent Application Publication
(10) Pub. No.: US 2013/0166590 A1
(43) Pub. Date: Jun. 27, 2013

(54) CONTENT SEARCH RECOMMENDATION APPARATUS AND METHOD BASED ON SEMANTIC NETWORK

(71) Applicant: Myung Eun KIM, Daejeon (KR)

(72) Inventor: Myung Eun KIM, Daejeon (KR)

(73) Assignee: Electronics and Telecommunications Research Institute, Daejeon (KR)

(21) Appl. No.: 13/620,652

(22) Filed: Sep. 14, 2012

(30) Foreign Application Priority Data
Dec. 27, 2011 (KR) 10-2011-0143491

(51) Int. Cl. G06F 17/30

(52) U.S. Cl. 707/769; 707/E17.014

(57) ABSTRACT

A content search recommendation apparatus and method based on a semantic network are provided. The content search recommendation apparatus may include a watch history storage to store a watch history of a user, a mobile device to receive input of a user command and transmit the user command, a smart agent server to extract a content name from the watch history in response to the user command and to output knowledge information corresponding to the content name, and a search recommendation server to search for the knowledge information related to the content name from a content knowledge information storage that stores and manages content knowledge information in the form of a semantic network, and to transmit a search result to the smart agent server.

### CROSS-REFERENCE TO RELATED APPLICATION

This application claims the benefit of Korean Patent Application No. 10-2011-0143491, filed on Dec. 27, 2011, in the Korean Intellectual Property Office, the disclosure of which is incorporated herein by reference.

### BACKGROUND

1. Field of the Invention

The present invention relates to a content search recommendation apparatus and method based on a semantic network, which recommends content related to content watched by a user to enhance multimedia content consumption in a smart television (TV) environment.

2. Description of the Related Art

Recently, as broadcasting and communication infrastructures are combined, a function of a television (TV) is being developed from a passive device that receives terrestrial broadcasting and delivers broadcasting content to users to a smart device that enables internet full browsing and execution of various applications demanded by users.

A conventional TV has been used in such a manner that a user leans back on the sofa and watches video transmitted by a terrestrial broadcasting station at a designated time. However, combination of the TV and the Internet is bringing change into a video consumption pattern. Nowadays, the user consumes any desired video any time and anywhere through not only the terrestrial broadcasting but also the Internet, leaning forward, that is, more positively.

According to a conventional pattern of consuming multimedia content on the Internet, mostly, the user searches for desired multimedia content through content related information such as a content title, a performer, a director, and the like. However, the search may be difficult when the user is not aware of correct information related to the content.

Although most of current content providers provides three or four search keys to help the user search for desired content, this function is so limited. In addition, compared to a computer environment, the TV has limits in terms of an input and output function. Therefore, it is difficult for the user to search for content by inputting search terms using a portable terminal such as a remote controller.

Accordingly, there is a desire for a new scheme and method for multimedia content search recommendation, being applicable to a smart TV environment and overcoming restriction in an input and output device and limits in search terms.

### SUMMARY

An aspect of the present invention provides a content search recommendation apparatus and method based on a semantic network, to overcome restriction in an input and output device and limits in search terms of a conventional television (TV) environment, by providing a user with related content knowledge information as a search term based on the semantic network in a smart TV environment, and to enable efficient search of multimedia content.

According to an aspect of the present invention, there is provided a content search recommendation apparatus including a watch history storage to store a watch history of a user; a mobile device to receive input of a user command and transmit the user command; a smart agent server to extract a content name from the watch history in response to the user command and to output knowledge information corresponding to the content name; and a search recommendation server to search for the knowledge information related to the content name from a content knowledge information storage that stores and manages content knowledge information in the form of a semantic network, and to transmit a search result to the smart agent server.

According to another aspect of the present invention, there is provided a content search recommendation method including storing a watch history of a user; receiving input of a user command and transmitting the user command; extracting a content name from the watch history in response to the user command; searching for knowledge information related to the content name from a content knowledge information storage that stores and manages content knowledge information in the form of a semantic network; and outputting the knowledge information corresponding to the content name.

### Effect

According to embodiments of the present invention, a smart television (TV) suggests a search term in advance using related knowledge information of content watched by a user so that the user may easily search for other content similar to the watched content. Therefore, restriction in an input and output device and limits in search terms of a conventional TV may be overcome, and related content may be easily searched.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a structure of a content search recommendation apparatus based on a semantic network, according to an embodiment of the present invention;

FIG. 2 is a diagram illustrating a related knowledge information graph interface, according to an embodiment of the present invention; and

FIG. 3 is a diagram illustrating a content search recommendation method based on a semantic network, according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

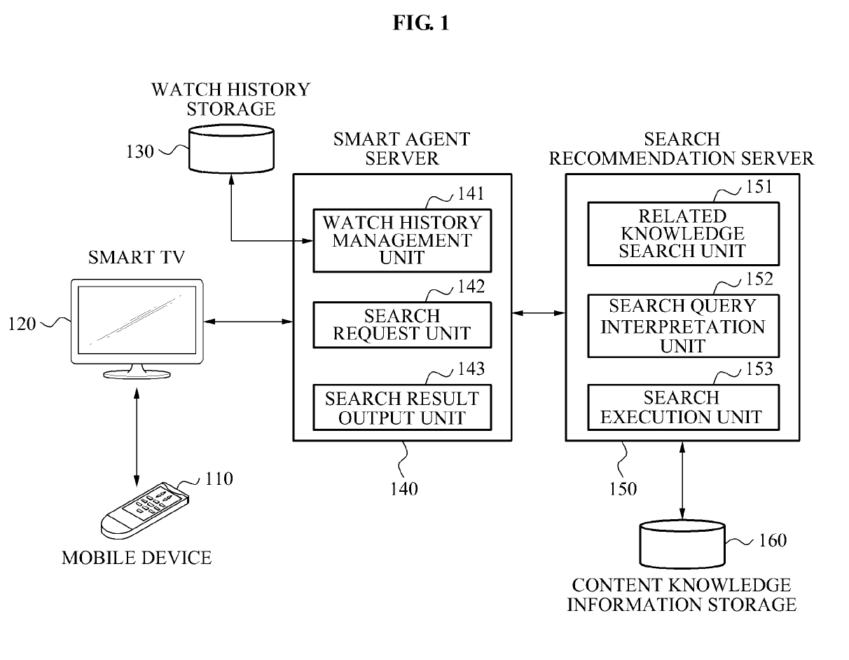

FIG. 1 is a block diagram illustrating a structure of a content search recommendation apparatus based on a semantic network, according to an embodiment of the present invention.

As shown in FIG. 1, the content search recommendation apparatus may include a mobile device 110, a smart television (TV) 120, a watch history storage 130, a smart agent server 140, a search recommendation server 150, and a content knowledge information storage 160.

The content knowledge information storage 160 may store and manage, in the form of a semantic network, knowledge information related to broadcasting content stored in a local storage and video-on-demand (VOD) content.

The watch history storage 130 may store a watch history of content watched through the smart TV 120 by the user logging in the smart TV and operating the mobile device 110.

The mobile device 110 may transmit, to a search request unit 142 of the smart agent server 140, a related content recommendation command input by the user after watching broadcasting content through the smart TV 120.

A watch history management unit 141 of the smart agent server 140 may inquire the watch history storage 130 to search for a latest watch history of the user, and transmit the latest watch history to the search request unit 142 of the smart agent server 140.

The search request unit 142 of the smart agent server 140 may extract a content name from the watch history stored in the watch history storage 130 and transmit the content name to a related knowledge search unit 151 of the search recommendation server 150.

The related knowledge search unit 151 of the search recommendation server 150 may search for tagged information to be used as a search term, from the knowledge information related to the corresponding content stored in the content knowledge information storage 160.

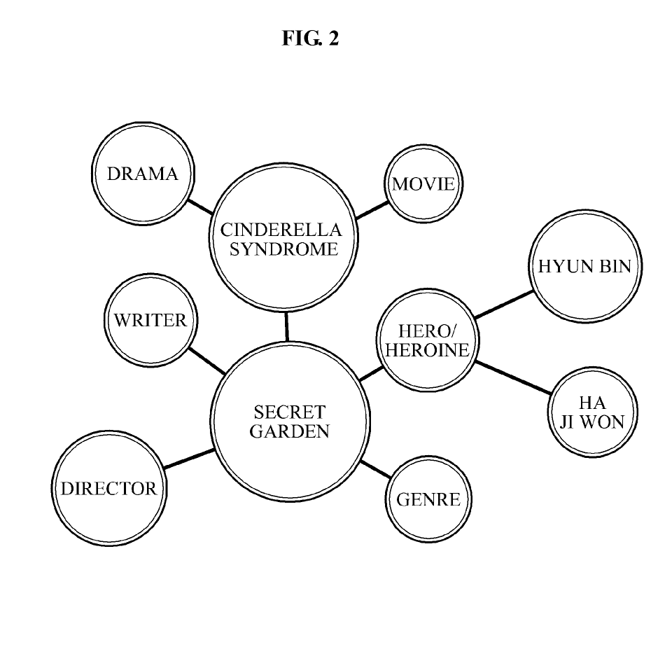

A search result output unit 143 of the smart agent server 140 may output the related knowledge information in the form of a graph such as a related knowledge information graph interface shown in FIG. 2, and transmit the related knowledge information to the smart TV 120.

The mobile device 110 may transmit graph node information selected by the user to be used as the search term in a graph interface in which the related knowledge information is expressed, to the search request unit 142 of the smart agent server 140.

The search request unit 142 of the smart agent server 140 may convert the graph node information selected by the mobile device 110 to a search query, and transmit the search query to a search query interpretation unit 152 of the search recommendation server 150.

The search query interpretation unit 152 of the search recommendation server 150 may identify individual knowledge information corresponding to the search query in the content knowledge information storage 160, interpret meaning of the search query, and transmit the interpreted search query to a search execution unit 153.

The search execution unit 153 of the search recommendation server 150 may convert the interpreted search query into a query, thereby executing search, and transmit a content list as the search result to the search result output unit 143 of the smart agent server 140.

The search result output unit 143 of the smart agent server 140 may convert the content list to correspond to a user interface and transmit the converted content list to the smart TV 120. The smart TV 120 may display the content list received from the smart agent server 140.

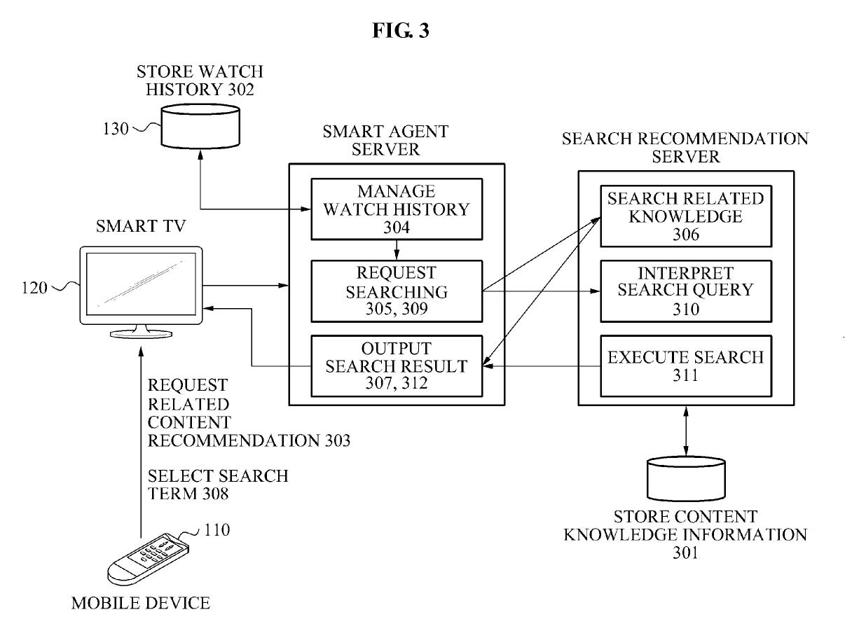

FIG. 3 is an operation flowchart illustrating a content search recommendation method based on a semantic network, according to an embodiment of the present invention.

The content search recommendation method may be implemented by the content search recommendation apparatus illustrated in FIG. 1. Hereinafter, for understanding of the invention, a description about FIG. 3 will be made also with reference to FIG. 1.

In operation 301, the content search recommendation apparatus may store and manage, in the form of a semantic network, knowledge information related to broadcasting content and VOD content by a content knowledge information storage.

In operation 302, the content search recommendation apparatus may store a watch history of the broadcasting content and the VOD content watched latest by the user by a watch history storage.

In operation 303, the content search recommendation apparatus may transmit, to a smart agent server, a related content recommendation command input from a mobile device. The related content recommendation command may be generated by a function performed in the mobile device.

In operation 304, the content search recommendation apparatus may search for a latest watch history from the watch history storage and transmit the search result to a search request unit, by a watch history management unit.

In operation 305, the content search recommendation apparatus may transmit information on content watched latest as the search result of the latest watch history searched from the watch history storage, by the search request unit.

In operation 306, the content search recommendation apparatus may search for information related to corresponding content based on the information on content watched latest as the search result, by a related knowledge search unit.

In operation 307, the content search recommendation apparatus may output the related knowledge to an interface in the form of a graph, such as a related knowledge information graph interface, by a search result output unit.

In operation 308, the content search recommendation apparatus may select and transmit graph node information to be used as the search term in the related knowledge information graph interface, by the mobile device.

In operation 309, the content search recommendation apparatus may convert the graph node information selected from the related knowledge information graph interface into a user search query and transmit the user search query to a search recommendation server, by the search request unit.

In operation 310, the content search recommendation apparatus may identify individual knowledge information related to the user search query and interpret meaning of the user search query based on the content knowledge information, by a search query interpretation unit.

In operation 311, the content search recommendation apparatus may input the interpreted search query to a content knowledge information storage and accordingly execute search with respect to a content list, by a search execution unit.

In operation 312, the content search recommendation apparatus may output the content list in the form of a list, searched by the content knowledge information storage, and provide the content list to the user, by the search result output unit.

The above-described embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A content search recommendation apparatus comprising:
a watch history storage to store a watch history of a user;
a mobile device to receive input of a user command and transmit the user command;
a smart agent server to extract a content name from the watch history in response to the user command and to output knowledge information corresponding to the content name; and
a search recommendation server to search for the knowledge information related to the content name from a content knowledge information storage that stores and manages content knowledge information in the form of a semantic network, and to transmit a search result to the smart agent server.

2. The content search recommendation apparatus of claim 1, wherein the smart agent server comprises:
a search result output unit to output the knowledge information in the form of a graph.

3. The content search recommendation apparatus of claim 2, wherein the mobile device transmits graph node information selected by the user from the knowledge information output in the form of the graph, to the smart agent server.

4. The content search recommendation apparatus of claim 3, wherein the smart agent server comprises:
a search request unit to convert the graph node information into a search query and to transmit the search query to the search recommendation server.

5. The content search recommendation apparatus of claim 4, wherein the search recommendation server comprises:
a search query interpretation unit to identify individual knowledge information corresponding to the search query in the content knowledge information storage, to interpret meaning of the search query, and to transmit the interpreted search query.

6. The content search recommendation apparatus of claim 5, wherein the search recommendation server comprises:
a search execution unit to execute search by converting the interpreted search query into a query, and to transmit a content list as the search result to the smart agent server.

7. The content search recommendation apparatus of claim 6, wherein the smart agent server comprises:
a search result output unit to convert the content list to correspond to a user interface and to transmit the content list to a smart television (TV).

8. The content search recommendation apparatus of claim 1, wherein the smart agent server comprises:
a watch history management unit to log and manage the watch history of the user in the watch history storage.

9. A content search recommendation method comprising:
storing a watch history of a user;
receiving input of a user command and transmitting the user command;
extracting a content name from the watch history in response to the user command;
searching for knowledge information related to the content name from a content knowledge information storage that stores and manages content knowledge information in the form of a semantic network; and
outputting the knowledge information corresponding to the content name.

10. The content search recommendation method of claim 9, wherein the outputting comprises:
outputting the knowledge information in the form of a graph.

11. The content search recommendation method of claim 10, wherein the outputting comprises:
transmitting graph node information selected by the user from the knowledge information output in the form of the graph.

12. The content search recommendation method of claim 11, wherein the transmitting comprises:
converting the graph node information into a search query and transmitting the search query.

13. The content search recommendation method of claim 12, wherein the transmitting comprises:
identifying individual knowledge information corresponding to the search query from the content knowledge information storage, interpreting meaning of the search query, and outputting the interpreted search query.

14. The content search recommendation method of claim 13, wherein the outputting comprises:
executing search by converting the interpreted search query into a query and transmitting a content list as a search result.

15. The content search recommendation method of claim 14, wherein the transmitting comprises:
converting the content list to correspond to a user interface and transmitting the converted content list.
